(19) United States
(12) Patent Application Publication
(10) Pub. No.: US 2005/0246325 A1
(43) Pub. Date: Nov. 3, 2005

(54) Method and system for recording and accessing usage of an item in a computer system

(75) Inventors: Fabio Pettinati, Redmond, WA (US); Dejan Subotic, Redmond, WA (US); Jon Perlow, Seattle, WA (US)

Correspondence Address: MICROSOFT CORPORATION;C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/836,776

(22) Filed: Apr. 30, 2004

(51) Int. Cl. G06F 7/00

(52) U.S. Cl. 707/3

(57) ABSTRACT

A method and system for recording and accessing usage of an item allows a user to select from a list of previously used items across a computing system. A relationship is established between a used item (e.g., a contact) and a usage pattern. The usage pattern records the number of times that the item is accessed. The usage pattern is available across the system such that multiple applications may retrieve the usage pattern to obtain information associated with a particular item. A weight factor associated with the relationship is generated and implemented in a ranking scheme. When a user begins typing the name of an item in a data field, the user is presented with a list of previously created items based on the ranking scheme. The user then selects the desired item from the list such that typing time is shortened and the user experience is enhanced.

### BACKGROUND OF THE INVENTION

Many software applications offer users the ability to select items of information from a list of previously used items. A user may be prompted with a list of files to open, contacts to send an e-mail message, or web pages to visit based on items in a “most recently used” cache. For example, when a user begins typing a uniform resource locator (URL) in the address bar of a web navigation application, the application suggests possible addresses based on the user's past history of entering URLs in the same application. The user may select an entry from a drop down menu rather than typing the remainder of the address. This feature reduces typing time and creates an improved user experience. However, the most recently used cache is specific to a particular application. Items recorded with reference to one application are not available in a different application.

### SUMMARY OF THE INVENTION

A method and system for recording and accessing usage associated with an item allows a user to select from a list a items previously used across a computing system. A relationship is established between a used item (e.g., a contact) and a usage pattern. The usage pattern records the number of times that the item is accessed. The usage pattern exists across the system such that multiple applications may retrieve the usage pattern to obtain historical information associated with a particular item. A weight factor associated with the relationship is generated and implemented in a ranking scheme. When a user begins typing the name of an item in a data field, the user is presented with a list of items that is created based on the ranking scheme. The user then selects the desired item from the list such that typing time is shortened.

According to one aspect of the invention, a usage pattern is associated with an item and a relationship type. The usage pattern and the associated relationship type is retrieved. A new relationship type is created if the relationship type previously did not exist in the retrieved usage pattern. A new relationship is created between the item and a property if the item did not exist in the retrieved usage pattern. The property is associated with the relationship type. A previously existing relationship between the item and the property is updated if the item and the relationship type previously existed in the retrieved usage pattern.

According to another aspect of the invention, at least one property is extracted from the usage pattern. The at least one property is provided to an output interface. A user selects a property from the at least one property. Historical information associated with the selected property is updated.

According to another aspect of the invention, a weight factor associated with the relationship is used to rank the items based on a predetermined criteria.

According to another aspect of the invention, an age factor associated with the relationship is used to determine the likelihood of item access.

### BRIEF DESCRIPTION OF THE DRAWINGS

FIG. 1 illustrates a computing device that may be used according to an example embodiment of the present invention.

FIG. 2 is a functional block diagram illustrating a system for recording and accessing usage associated with an item, in accordance with the present invention.

FIG. 3 is a functional block diagram illustrating a system for recording and accessing usage associated with an item associated with an e-mail application, in accordance with the present invention.

FIG. 4 is a functional block diagram illustrating a system for recording and accessing usage associated with an item associated with a telephony application, in accordance with the present invention.

FIG. 5 is a functional block diagram illustrating a system for recording and accessing usage associated with an item, in accordance with the present invention.

FIG. 6 is an operational flow diagram illustrating a process for recording usage associated with an item, in accordance with the present invention.

FIG. 7 is an operational flow diagram illustrating a process for accessing usage associated with an item, in accordance with the present invention.

### DETAILED DESCRIPTION OF THE PREFERRED EMBODIMENT

Briefly stated, a method and system for recording and accessing usage associated with an item allows a user to select from a list of previously used items across a computing system. A relationship is established between a used item (e.g., a contact) and a usage pattern. The usage pattern records the number of times that the item is accessed. The usage pattern is available across the system such that multiple applications may retrieve the usage pattern to obtain historical information associated with a particular item. A weight factor associated with the relationship is generated and implemented in a ranking scheme. When a user begins typing the name of an item in a data field, the user is presented with a list of previously created items based on the ranking scheme. The user then selects the desired item from the list such that typing time is shortened and the user experience is enhanced.

An example of the present invention may be explained in reference to contacts in an e-mail application. A system for recording and accessing usage of a contact provides a user with the ability to complete an e-mail address associated with the contact. For example, the user may type “de” in a data field and the system references the past history of all contacts that the user has previously sent e-mail messages. If any names beginning with “de” are found, the system suggests the name (or list of names) to the user. The system ranks the names based on the usage pattern of the address associated with the contact.

Illustrative Operating Environment

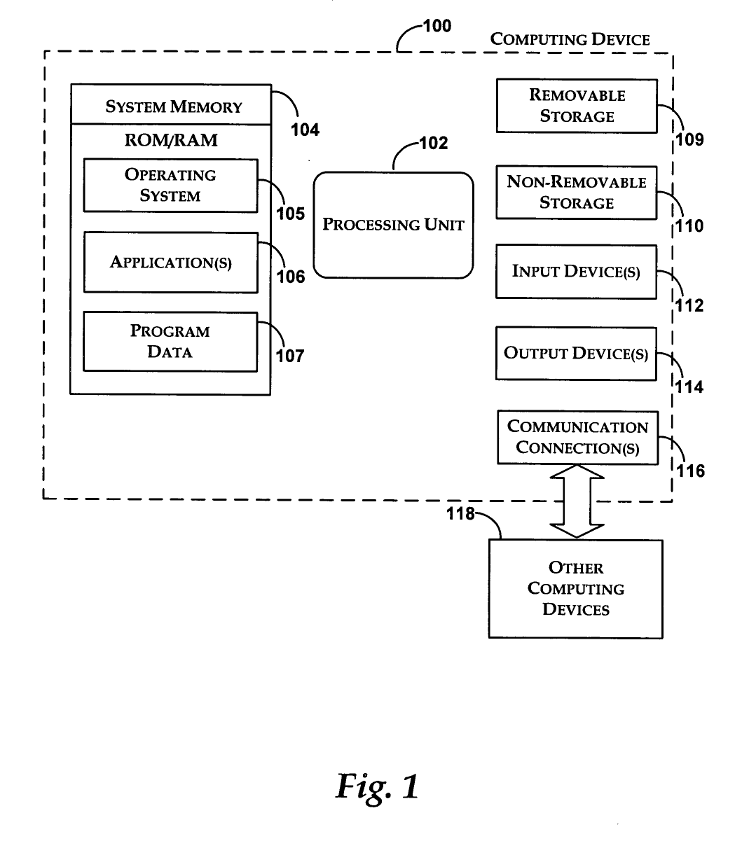

With reference to FIG. 1, one example system for implementing the invention includes a computing device, such as computing device 100. Computing device 100 may be configured as a client, a server, mobile device, or any other computing device that interacts with data in a network based collaboration system. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. The present invention, which is described in detail below, is implemented as an application.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Recording Usage of an Item

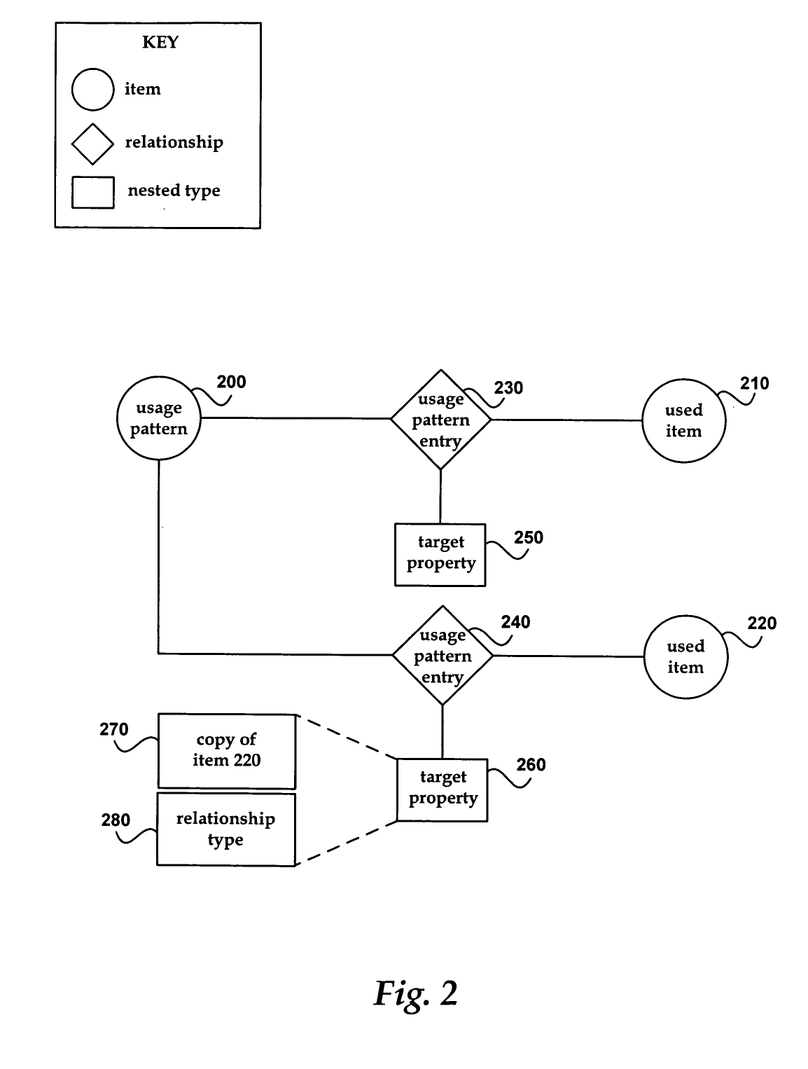

FIG. 2 is a functional block diagram illustrating a system for recording and accessing usage associated with an item. The system includes items, relationships and nested types.

An item is a unit that the user may operate upon (e.g., access, share, archive, etc.) For example, a user may copy, open or view an item. Some examples of items include a contact (e.g., a person, group, or organization, and all associated metadata), an e-mail address, an instant messaging address, a telephone number, a fax number, a message, a list, a document, a file, a uniform resource locator (URL), a photograph, and a video. The items shown in the figure include usage pattern 200 and previously used items 210, 220. Usage pattern 200 may be a repository that records a user's history in reference to previously used items within the system. When a user attempts to reuse an item, the system suggests a best match based on the usage pattern.

A relationship is established between two items. For example, one item may be a person and another item may be a photograph. A relationship may be established between the two items because the person appears in the photograph. Usage pattern 200 is the source of the relationship, and used items 210, 220 are the targets. Usage pattern 200 may be a collection of relationships between previously used items and a particular source. The relationships shown in the figure include usage pattern entries 230, 240.

A nested type (shown in the figure as target properties 250, 260) includes a copy of the associated item (270) and a relationship type identified by the item (280). Examples of relationship types include “e-mail address”, “telephone number”, “fax number”, “instant messaging address”, “document”, “file”, “URL”, “photograph”, and “video”. The relationship type is a label that describes the item. For example, an item may be “(202) 555-1234” and the associated relationship type is “telephone number.” Each relationship stores additional information associated with the item (e.g., frequency of access, time and date of last access, etc.) such that the usage pattern may rank, age and/or filter the relationship relative to other relationships.

Used item 220 may be null, which would make usage pattern entry 240 a dangling relationship. Dangling relationships may be useful when there is no need to associate a target property with an item.

Usage pattern entries 230, 240 may include additional properties that represent the actual usage of the corresponding target properties 250, 260. Usage pattern entries 230, 240 also provide context for ranking entries which is described in detail below. In one embodiment, ranking is performed based on the likelihood that the user intends to access a particular item. In another embodiment, ranking is performed based on the date and time the item was last accessed. In another embodiment, ranking is performed based on the frequency of item access.

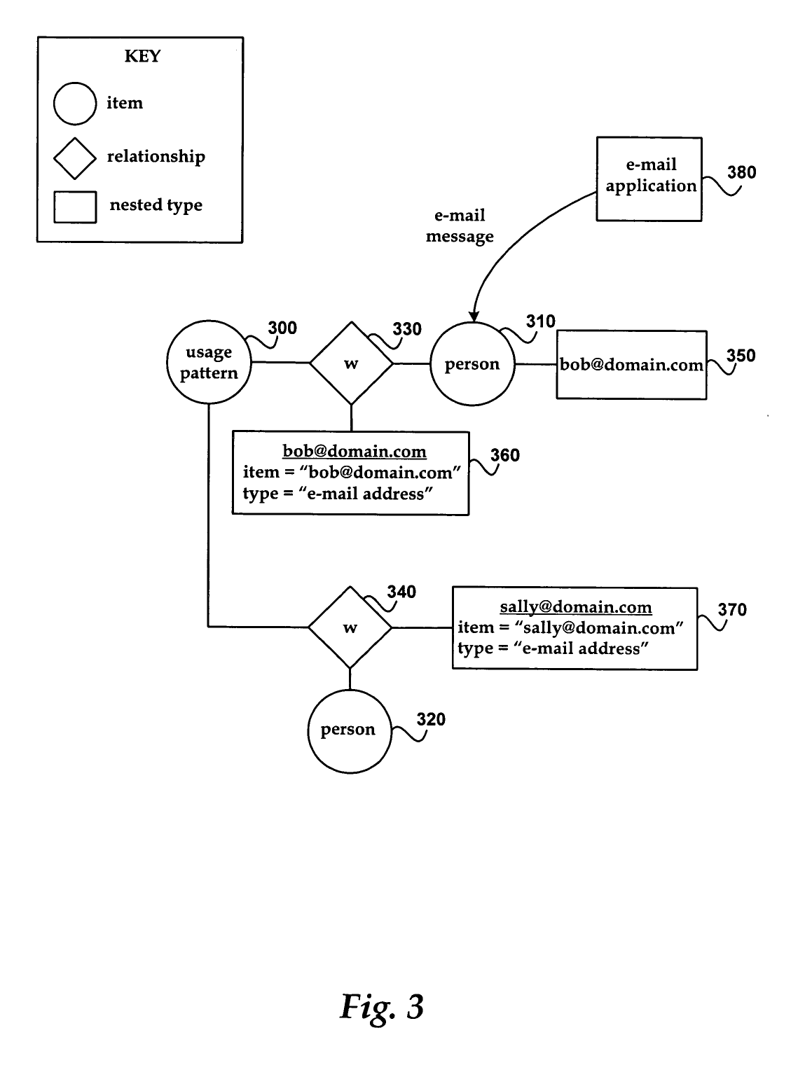

FIG. 3 is a functional block diagram illustrating a system for recording and accessing usage of an item associated with an e-mail application. The system includes items, relationships and nested types. Specifically, the items shown in the figure include usage pattern 300 and persons 310, 320. Relationship 330 is established between usage pattern 300 and person 310. Relationship 340 is established between usage pattern 300 and person 320. Nested type 350 is associated with person 310. Nested type 360 is associated with relationship 330. Nested type 370 is associated with relationship 340.

E-mail application 380 sends an e-mail message to person 310 having e-mail address “bob@domain.com” such that relationship 330 is established between usage pattern 300 and person 310. E-mail application 380 records that the e-mail message has been sent by adding the relevant information to usage pattern 300. In one embodiment, the information that is added includes the item and the property type associated with the item. As shown in the figure, nested type 350 (i.e., bob@domain.com) is associated with person 310. Nested type 360 includes a copy of the email address “bob@domain.com” and the property type associated with the item (i.e., “e-mail address”).

Relationship 330 is updated whenever e-mail application 380 sends an e-mail message to bob@domain.com. E-mail application 380 retrieves usage pattern 300 before sending an e-mail message to access any relationships associated with person 310. E-mail application 380 records where the e-mail message was sent such that potential recipients of the e-mail message may be presented to the user based on a ranking scheme. In one embodiment, the user is presented with a message in an output interface that prompts the user with the most likely destination that the user intends to send the e-mail message. For example, the user interface may display “Do you want to send an e-mail message to Bob?”

The e-mail address is copied in nested type 360 because the e-mail address associated with person 310 may be deleted but it may be necessary to e-mail that person later at the deleted address. If a user is associated with more than one e-mail address, the specific address that is used is recorded in the usage pattern. The used e-mail address is copied even if relationship 330 previously existed.

Usage pattern 300 may record information associated with other items. As shown in the figure, usage pattern 300 records information related to person 320. In one embodiment, usage pattern 300 also records information associated with the usage of the e-mail address “sally@domain.com.”

Each time an application program accesses a data field, the properties are searched for all existing relationships between the usage pattern (e.g., 300) and the person (e.g., 310). If the relationship and corresponding property are found, a weight factor (w) associated with the item is modified. The weight factor maintains information about the usage of an item. The weight factor is associated with the relationship between two items such as between usage pattern 300 and person 310. The weight factor may be used to provide historical information associated with the item. In one embodiment, the weight factor is used to determine the likelihood that the item is the one that the user intends to access. The weight factor is described in detail below with reference to the ranking scheme.

Each item is associated with a unique weight factor. For example, a user may have two e-mail addresses which create two different relationships between the usage pattern and the particular e-mail address. A relationship may be created and associated with the user using whatever property caused the relationship to be established. For example, if the same user is later called on the telephone, a third relationship may be created that is identified by a “telephone number” property.

A usage pattern application program interface (API) allows multiple usage patterns to be defined within the system. An item may be associated with more than one usage pattern. Applications create and access usage patterns through the usage pattern API such that any one application may access multiple usage patterns. For example, an Internet browser application has access to a list of people that a user has e-mailed in an e-mail application. Both the browser application and the e-mail application may also access a list of people that a user has had instant messaging conversations with. Similarly, two different e-mail applications may share the same list of people that a user has sent e-mail messages to. The usage pattern API also allows applications to: create a new usage pattern in a specific folder; access a previously created usage pattern; add or update an entry in a usage pattern; retrieve a list of all entries in a usage pattern; purge the contents of a specific usage pattern; and purge the contents of all usage patterns in the system.

Different forms of communication generate different relationship types associated with the usage pattern. For example, one usage pattern may be associated with contacts, while another usage pattern may be associated with documents. A document usage pattern establishes a relationship between documents of the system and the usage pattern. For example, a document usage pattern used in conjunction with a document application may display a list of recently opened documents such that the user need not manually enter document names for previously accessed documents.

A usage pattern may be created system-wide based on the usage of an item in different applications. One application in the system may rely on the use of an item in other applications of the system to glean information about that item. Other applications may retrieve the usage pattern to provide relevant information to the user. For example, sending daily e-mail messages to the same person creates a usage pattern where the person figures prominently. In a word processing application, the user may begin typing an e-mail address that starts with the same letters as the person's e-mail address. The system suggests the person's e-mail address to the user such that the user need only accept the suggestion (e.g., by clicking a mouse, hitting enter, etc.) rather than typing the remainder of the e-mail address.

The system is described in reference to e-mail application 380. However, the present invention may be adapted to any software application. For example, in a telephony application, a person who has been contacted (e.g., via e-mail, instant messaging, telephone, fax, etc.) has an associated usage pattern that indicates the frequency of contact and the method employed for contact (e.g., e-mail, telephone, instant messaging, etc.) In one example, the usage pattern creates an association between a user and telephone calls to a person at a particular time of day.

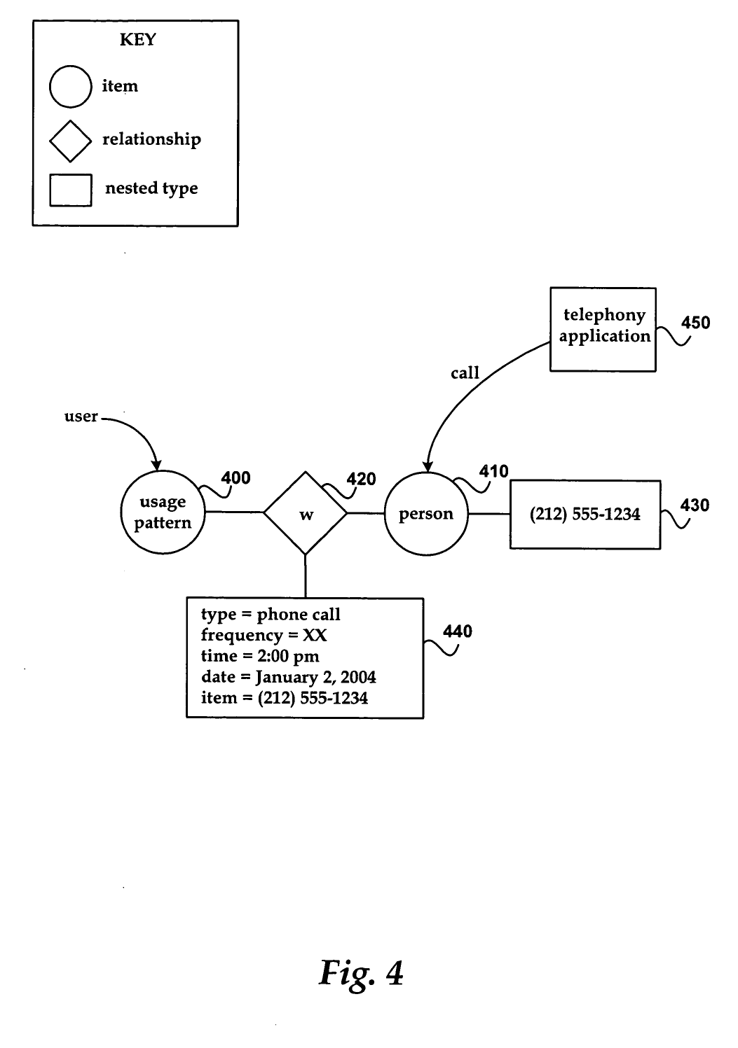

FIG. 4 is a functional block diagram illustrating a system for recording and accessing usage of an item associated with a telephony application. The system includes items, relationships and nested types. Specifically, the items shown in the figure include usage pattern 400 and person 410. Relationship 420 is established between usage pattern 400 and person 410. Nested type 430 is associated with person 410. Nested type 440 is associated with relationship 420.

Telephony application 450 calls to person 410 such that relationship 420 is established between usage pattern 400 and person 410. The property that causes relationship 420 to be established is the call to the phone number (e.g., (212) 555-1234) associated with person 410. Telephony application 450 records that the telephone call was connected by adding the relevant information to usage pattern 400. As shown in the figure, nested type 440 is a database record that includes information associated with the telephone call including the property type (e.g., phone call), the frequency with which the person is called (calculated using an algorithm), the time and date that the item was last accessed (e.g. 2:00 pm, Jan. 2, 2004), and the item (e.g., the telephone number).

In one embodiment, usage pattern 400 records call history information associated with person 410. Usage pattern 400 determines that a user calls person 410 (e.g., spouse, child, parent) at a particular time of day. When the time approaches, telephony application 450 may suggest person 410 to the user by displaying a message on a user interface of the user's telephone (e.g., “Do you want to call your husband at home?”)

In one embodiment, the usage pattern is synchronized on several associated computers. In another embodiment, it is undesirable to have the usage pattern available across an entire system for security reasons. In this example, the usage pattern is created such that it is only available to a particular application, domain, or user. A user may create additional usage patterns associated with an item such that one usage pattern may be available across the system, while another is only available to a particular application. The user may also delete the contents of a usage pattern to protect user-sensitive information in a public environment.

In one example of an application-specific usage pattern, a usage pattern associated with a customer management application maintains information about the likelihood of a customer ordering a particular product. A customer's previous ordering data is used to anticipate what the customer's current order will be. Thus, the process of providing useful information to a customer is simplified with usage patterns.

In another example, a usage pattern is applied to a specific domain such as a domain used in relation to health care. A doctor may enter a particular prescribed medication in a text field of a patient information database. The usage pattern may be associated with names of prescription drugs such that the system suggests potential medications that might be entered into the text field based on medications previously prescribed to the patient. For example, the doctor may enter the letter “a” into the text field. The system suggests medications previously prescribed to the patient that begin with the letter “a”. When the patient is billed using an accounting application, the system may provide the names of medications entered into the patient information database such that bill preparation is simplified.

A ranking scheme provides a method for suggesting to the user a list of items in a particular order. A particular ranking scheme is selected when a usage pattern is retrieved. In one embodiment, available ranking schemes include most likely accessed items, most frequently accessed items, most recently accessed items, alphabetical order, numerical order, ascending order, and descending order. In a contact-specific application, a most frequently accessed list of contacts is ranked by how often the contact has been selected over a period of time. A most recently accessed list of contacts is ranked by age of access (i.e., the time elapsed since the contact was last selected). A most likely accessed list of contacts is ranked by a combination of frequency of access and age of access.

As discussed above, each relationship has an associated weight factor (w). The weight factor maintains historical information associated with an item. In one embodiment, multiple weight factors may be associated with one relationship. The weight factor is updated each time an associated item is accessed. In one embodiment, the weight factor is an integer that is incremented each time the item is accessed. Updating a weight factor updates all weight factors associated with a particular relationship.

Different ranking schemes other than a single integer are also available. For example, a flag may be set stating that only the most recently accessed items are of interest. In this example, the weight factor can determine most recent usage by calculating the amount of time elapsed since the last time the item was accessed.

The weight factor is computed each time a property is used. In one embodiment, the weight factor (w) is computed using the following equation:
w=w+2¹⁷

A corresponding age factor associated with an item is computed using the following equation:
if (date_last_aged>7 days in the past)
then w=w/2.
if w=0 (integer division)
then delete the property.

For example, when a person is sent an e-mail for the first time, w=2¹⁷. The person is not sent an e-mail message for a week such that the weight factor is divided by two (w=2¹⁶). The following week, the person is not sent an e-mail message (w=2¹⁵), and so on. After 17 weeks of not receiving an e-mail message from the user, the weight factor is zero. Thus, information associated with the person is not available to the user when the system presents the user with most likely to be accessed items.

The weight factor associated with the property decays exponentially when the item is not accessed for a period of time (e.g., seventeen weeks). The exponential decay provides an age factor for the item such that the system recognizes when a user loses interest in a particular item.

If a user sends e-mail messages to a person on a daily basis, that person's e-mail address figures prominently in the usage pattern. However, if the user discontinues sending e-mail messages to the person while continuing to send others messages, the likelihood that an e-mail message is intended for the person diminishes. For example, a person may have been sent one hundred e-mail messages three weeks ago but has not been sent any e-mail messages since. That person is still less likely to receive an e-mail message than a person who received one e-mail message three days ago.

The weight factor may be updated by methods other than exponential decay. For example, the weight factor may be increased each time the associated item is accessed. When the weight factor reaches a predetermined value, the item will no longer be presented to the user as a possible entry that is most likely to be accessed.

In one embodiment, the weight factor is calculated using a function provided by an associated application. The application may have a specific requirement that requires the weight factor be accessed in a specific way. The function may be referenced through an API such that the user may call to the function to update the weight factor. In another embodiment, the application provides a domain-specific method for calculating the weight factor.

In one embodiment, the usage pattern is arranged such that no entries age. Thus, the usage pattern provides a complete communication history of the item.

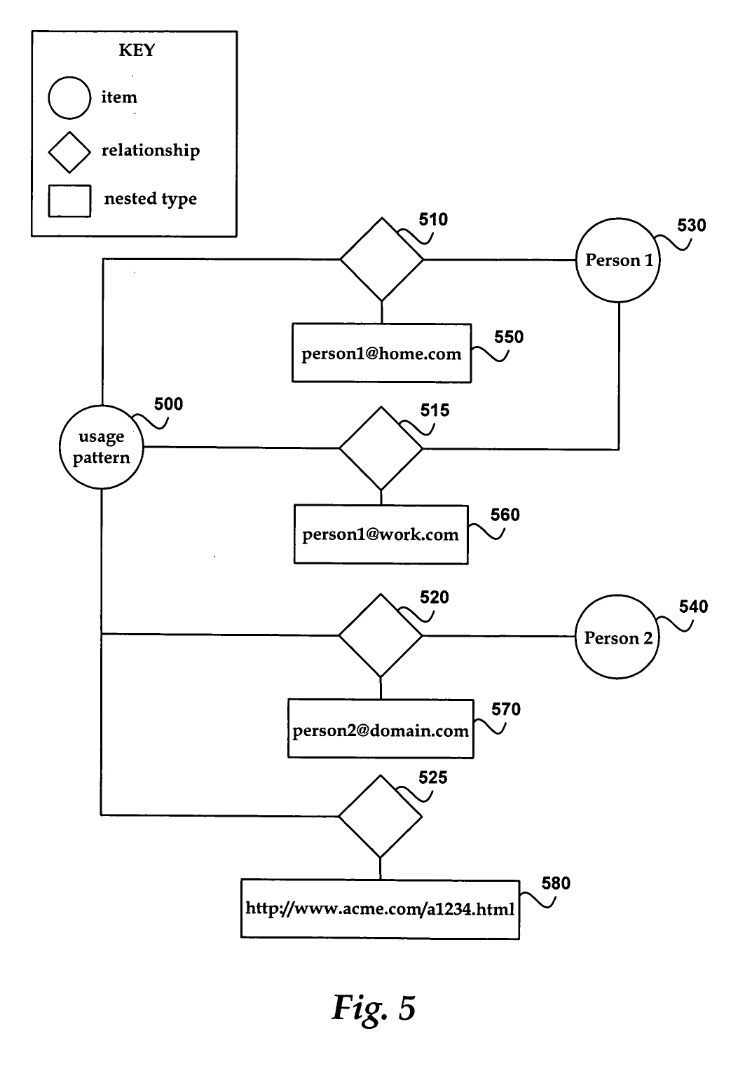

FIG. 5 is a functional block diagram illustrating a system for recording and accessing usage associated with an item. The system includes usage pattern 500, relationships 510, 515, 520, 525, items 530, 540, and nested types 550, 560, 570, 580.

Item 530 (i.e., person 1) has two associated relationships 510, 515, while item 540 (i.e., person 2) has one associated relationship 520. Relationship 510 records the usage of nested type 550 (i.e., person1@home.com). Relationship 515 records the usage of nested type 560 (i.e., person1@work.com). Relationship 525 is a dangling relationship, where the item previously associated with the usage pattern was previously deleted. The information recorded by relationship 525 is associated with a URL (i.e., http://www.acme.com/a1234.html) and is not associated with any particular item. Thus, usage pattern 500 may record information even if the information is not associated with an item (e.g., the item is null).

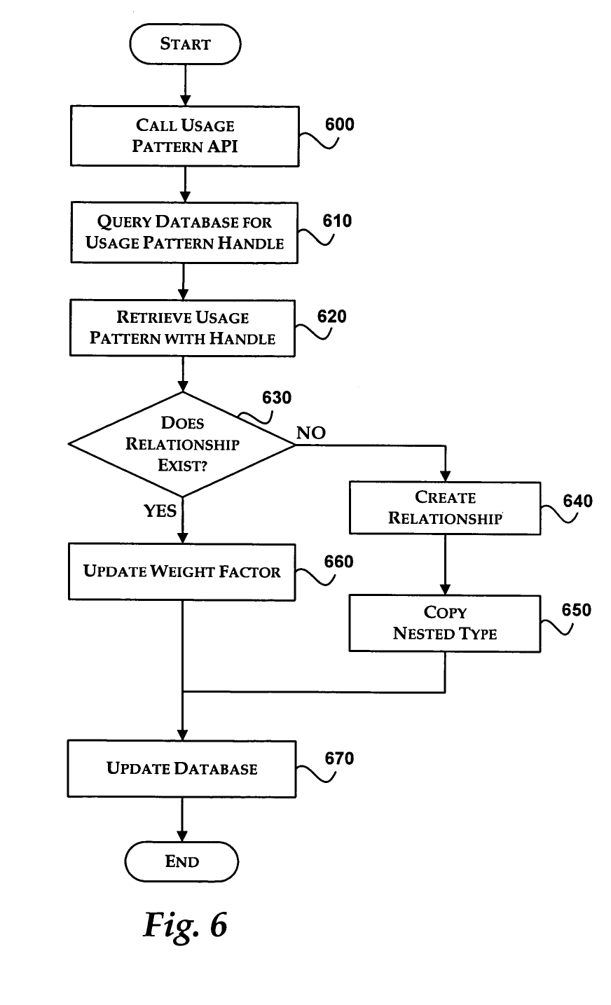

FIG. 6 is an operational flow diagram illustrating a process for adding an item to a usage pattern. The process begins at a start block where an item is accessed in an application.

The process moves to block 600 where the application calls a usage pattern API. A usage pattern is a repository of relationships that exist between the usage pattern and items. The usage pattern may be identified by a unique identifier. The application selects the desired usage pattern by selecting the appropriate identifier.

Proceeding to block 610, the usage pattern API queries a database to retrieve a usage pattern handle associated with the identified usage pattern. The database includes items, nested types, relationships, and other types of data as previously described. Moving to block 620, the application retrieves the usage pattern handle from the database such that relationships associated with the item may be accessed.

Continuing to block 630, a determination is made whether a relationship between the usage pattern and the item exists. The determination is made by querying the database. If a relationship exists, processing moves to block 660. If a relationship does not exist, processing continues at block 640.

Transitioning to block 640, a relationship is created between the item and the usage pattern when the item is accessed. Proceeding to block 650, a nested type is copied and associated with the relationship. The copy of the nested type includes a copy of the associated item and a property type which describes the type of information identified by the item. In one example, the copy of the item is “bob@domain.com,” and the property type is “e-mail address.” Other information included in the copy of the nested type may include information related to the frequency, date and time of item access.

Continuing to block 660, the weight factor associated with the relationship is updated. The weight factor maintains historical information about the usage of the item such that the item may be ranked and presented to the user based on predetermined criteria. In one embodiment, items are ranked based on the likelihood that the user intends to access the item. Items may also be ranked on frequency of access and time of last access. The weight factor is updated each time an associated item is accessed. For example, the weight factor associated with an e-mail address is updated each time an e-mail message is sent to the e-mail address.

Moving to block 670, the database is updated such that data associated with the item is recorded in the identified usage pattern. Processing then terminates at an end block.

An example portion of application program source code for calling the database is shown below.

Public PhoneManager( )
{

RequestedPattern = “recent phone calls”;
Upattern = GetUsagePattern(CurrentContext, RequestedPattern);
Entries = GetEntries(CurrentContext, Upattern);
foreach (entry in Entries)
{

person = entry.item as person;
t_number = entry.property as telephone_num;
if NumMatch(buffer, t_number)
{

display(t_number)
if select(t_number)
{

update(entry.access_date_time)
update(entry.weight_factor)

}

}

}

}

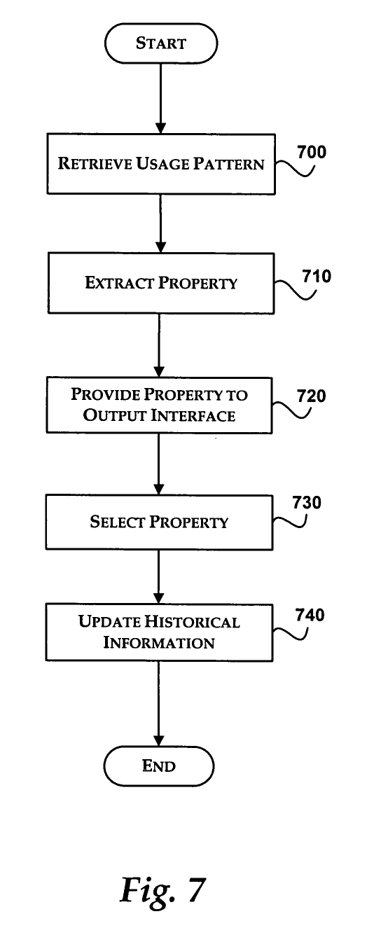

FIG. 7 is an operational flow diagram illustrating a process for accessing a usage pattern. The process begins at a start block where an item is accessed in an application.

The process moves to block 700 where a usage pattern associated with an item is retrieved. In one embodiment, the application calls a usage pattern API. The usage pattern API allows multiple usage patterns to be defined within the system. The usage pattern API queries a database to retrieve the usage pattern. The usage pattern is identified by a usage pattern handle. The application receives the usage pattern from the database.

Proceeding to block 710, a property is extracted from the usage pattern. The property describes the type of information associated with the item. The property is associated with a relationship that is established between the usage pattern and the item.

Moving to block 720, the property is provided to an output interface. The property provides a user with information associated with the item. In one embodiment, the information is related to the most likely to be accessed item.

Continuing to block 730, the user selects the property such that the item associated with the property is accessed. For example, a drop down menu displaying a list of items is shown in the user interface such that the most likely to be accessed item is displayed at the top of the list. The user may then select an item from the menu.

Advancing to block 740, historical information associated with the selected property is updated. In one embodiment, the historical information is related to the frequency, date, and time of item access. Processing then terminates at an end block.

The above specification, examples and data provide a complete description of the manufacture and use of the composition of the invention. Since many embodiments of the invention can be made without departing from the spirit and scope of the invention, the invention resides in the claims hereinafter appended.

1. A computer-implemented method for recording usage associated with an item that is used by an application program, the computer-implemented method comprising:
retrieving a usage pattern that is associated with a relationship type;
creating a new relationship type when the relationship type previously did not exist in the retrieved usage pattern;
creating a new relationship between the item and a property when the item does not exist in the retrieved usage pattern, wherein the property is associated with the relationship type; and
updating a previously existing relationship between the item and the property when the item and the relationship type previously existed in the retrieved usage pattern.

2. The computer-implemented method of claim 1, wherein retrieving the usage pattern further comprises:
selecting an identifier associated with the usage pattern based on the type of relationship;
requesting a handle associated with the selected identifier; and
receiving the handle in response to the request.

3. The computer-implemented method of claim 1, wherein retrieving the usage pattern further comprises creating a new usage pattern when the type of relationship is not found in an existing usage pattern.

4. The computer-implemented method of claim 1, wherein the relation type comprises at least one of a group consisting of: e-mail address, telephone number, fax number, instant messaging address, document, file, a uniform resource locator (URL), photograph, and video.

5. The computer-implemented method of claim 1, wherein the relationship type is identified by the type of property.

6. The computer-implemented method of claim 1, wherein the item comprises at least one of a group consisting of: a contact, an e-mail address, a telephone number, a fax number, an instant messaging address, a message, a list, a document, a file, a URL, a photograph, and a video.

7. The computer-implemented method of claim 1, wherein the relationship includes a copy of the item.

8. The computer-implemented method of claim 1, wherein the item is associated with a plurality of relationships.

9. The computer-implemented method of claim 1, further comprising associating a weight factor with the relationship, wherein the weight factor is updated when the relationship is updated.

10. The computer-implemented method of claim 9, further comprising ranking the items based on the weight factor, wherein the items are ranked based on at least one of a group comprising: most likely to be accessed, most frequently accessed, most recently accessed, alphabetical order, numerical order, ascending order, and descending order.

11. The computer-implemented method of claim 9, further comprising associating an age factor with the relationship based on the weight factor, wherein the likelihood of item access is determined based on the age factor and the weight factor.

12. The computer-implemented method of claim 1, further comprising making the usage pattern available to other application programs.

13. The computer-implemented method of claim 1, further comprising making the usage pattern unavailable to other users.

14. The computer-implemented method of claim 1, further comprising deleting the item such that the usage pattern is associated with a dangling relationship.

15. A computer-readable medium having computer executable instructions for recording usage associated with an item, comprising:
retrieving a usage pattern that is associated with a relationship type;
creating a new relationship type when the relationship type previously did not exist in the retrieved usage pattern;
creating a new relationship between the item and a property when the item does not exist in the retrieved usage pattern, wherein the relationship type is identified by the type of property; and
updating a previously existing relationship between the item and the property when the item and the relationship type previously existed in the retrieved usage pattern.

16. The computer-readable medium of claim 15, wherein retrieving the usage pattern further comprises creating a new usage pattern when the type of relationship is not found in an existing usage pattern.

17. The computer-readable medium of claim 15, wherein the relationship includes a copy of the item.

18. The computer-readable medium of claim 15, further comprising associating a weight factor with the relationship, wherein the weight factor is updated when the relationship is updated.

19. The computer-readable medium of claim 18, further comprising ranking the items based on the weight factor, wherein the items are ranked based on at least one of a group comprising: most likely to be accessed, most frequently accessed, most recently accessed, alphabetical order, numerical order, ascending order, and descending order.

20. The computer-readable medium of claim 18, further comprising associating an age factor with the relationship based on the weight factor, wherein the likelihood of item access is determined based on the age factor and the weight factor.

21. A computer-implemented method for accessing historical information associated with an item that is used by a first application program, the computer-implemented method comprising:
retrieving a usage pattern associated with an item;
extracting at least one property from the usage pattern, wherein the property is associated with an identified relationship type;
providing at least one property to an output interface;
selecting a property associated with the provided at least one property in response to a user selection; and
updating historical information associated with the selected property.

22. The computer-implemented method of claim 21, wherein the historical information is created by a second application program.

23. The computer-implemented method of claim 21, wherein the relationship type comprises at least one of a group consisting of: e-mail address, telephone number, fax number, instant messaging address, document, file, a URL, photograph, and video.

24. The computer-implemented method of claim 21, wherein the relationship type is identified by the type of property.

25. The computer-implemented method of claim 21, wherein the item comprises at least one of a group consisting of: a contact, an e-mail address, a telephone number, a fax number, an instant messaging address, a message, a list, a document, a file, a URL, a photograph, and a video.

26. The computer-implemented method of claim 21, wherein updating historical information further comprises updating a weight factor associated with the property.

27. The computer-implemented method of claim 26, further comprising ranking items based on the weight factor, wherein the items are ranked based on at least one of a group comprising: most likely to be accessed, most frequently accessed, most recently accessed, alphabetical order, numerical order, ascending order, and descending order.
